(19) United States
(12) Patent Application Publication
(10) Pub. No.: US 2015/0174872 A1
(43) Pub. Date: Jun. 25, 2015

(54) TOUGHENED COMPOSITE MATERIALS AND METHODS OF MANUFACTURING THEREOF

(71) Applicant: Cytec Engineered Materials Inc., Tempe, AZ (US)

(72) Inventors: Mark Richard Bonneau, Brea, CA (US); Gordon Emmerson, Los Alamitos, CA (US)

(21) Appl. No.: 14/564,295

(22) Filed: Dec. 9, 2014

Related U.S. Application Data
(60) Provisional application No. 61/919,975, filed on Dec. 23, 2013.

(51) Int. Cl. B32B 27/34; B32B 27/20; B32B 37/18

(52) U.S. Cl. CPC B32B 27/34; B32B 37/18; B32B 27/20; B32B 2250/02; B32B 2262/106; B32B 2262/101; B32B 2262/105; B32B 2307/558; B32B 2264/0214

(57) ABSTRACT

Disclosed herein are toughened composite materials, and methods for manufacturing thereof. At least one interleaf toughing particle and at least one polymer veil are used to synergistically increase the toughness of a fiber/polymer composite. The at least one interleaf toughening particle and at least one polymer veil can be located in the interlaminar sections of the composite material.

### BACKGROUND

1. Field of the Invention

Disclosed herein is a toughened composite material and method of manufacturing using a synergistic combination of veils and interleaf particles.

2. Description of the Related Art

Composite materials are formed from two or more constituent materials. The two or more materials can have different physical or chemical properties, and thus, when combined, can produce a composite material with properties that are different than the individual components. Many different types of materials can be engineered into composite materials. For example, cements and concretes can be made and used as building materials. Further, reinforced plastics, such as fiber-reinforced polymers, can be made and used in aerospace, sporting good, automotive, construction, military, and various other types of equipment. Other materials, such as metals and ceramics can also be formed into composites.

### SUMMARY

Disclosed herein is a toughened composite material which can comprise a first layer comprising a plurality of reinforcing fibers arranged in a fiber configuration and embedded in a polymer matrix, and a second layer contacting and at least partially covering the first layer, the second layer comprising a laminating matrix, wherein the laminating matrix comprises an interlaminar layer and at least one toughening particle embedded in the laminating matrix, wherein the interlaminar layer and the at least one toughening particle are selected in combination to synergistically provide the composite material with improved toughness.

The plurality of reinforcing fibers can be selected from a variety of fibers such as carbon fibers, glass fibers, ceramic fibers, and combinations thereof. In some embodiments, the at least one interlaminar layer includes a veil. In some embodiments, the at least one interlaminar layer includes a plurality of polymer fibers oriented in a different direction than a direction of the reinforcing fibers. In some embodiments, the at least one interlaminar layer includes a plurality of polymer fibers oriented in a generally random direction. In some embodiments, the at least one interlaminar layer includes a plurality of polymer fibers oriented in a same direction as a direction of the reinforcing fibers.

As noted above, the at least one interlaminar layer can include a veil. The veil can be a polyamide veil. Useful polyamide veils include PA 1453 (manufactured by Spunfab, Cuyahoga Falls, Ohio, USA and having a nylon-6 type polymeric chemistry), polyaramid, or PA 11 (Nylon 11, manufactured by Spunfab, Cuyahoga Falls, Ohio, USA). The at least one interlaminar layer can have an areal weight in the range of about 3 GSM to about 9 GSM, and preferably the at least one interlaminar layer has an areal weight of about 6 GSM.

The at least one toughening particle can be insoluble or at least partially soluble in the laminating matrix. Useful materials for the at least one toughening particle include a polyphenylene ether (PPE) based resin particle (available as PPO™ Resin 640 from Sabic, Pittsfield, Mass., USA), polyether sulfone particles (available as xKM particles from Cytec Industries Inc., Woodland Park, N.J., USA), polyimides particles prepared from benzophenone tetracarboxylic acid dianhydride (BTDA), 4,4′-methylenedianiline (MDA), and 2,4-toluenediamine (TDA) and having a non-phthalimide carbon content which contains between 90 and 92 percent aromatic carbons (commercially available as P84® from Lenzing AG, Lenzing, Austria) or polyimide particles based on BTDA and PMDA monomers reacted with isocyanates to produced fully imidized polyimide (commercially available as P84 polyimide resins from HP Polymer Inc., Lewisville, Tex., USA), and combinations thereof. The laminating matrix can include an amount of the at least one toughening particle in a range of about 5 wt. % to about 15 wt. %, based on total weight of the laminating matrix and toughening particles.

Also disclosed herein is a method of forming a composite material comprising providing a first layer comprising a prepreg, at least partially contacting and covering the first layer with a second layer comprising an interlaminar layer, laminating the first and second layer with a third layer to form a laminated prepreg, the third layer comprising at least one toughening particle embedded into a laminating matrix, and curing the laminated prepreg to form a composite material, wherein the interlaminar layer and the at least one toughening particle are selected in combination to synergistically provide the composite material with improved toughness.

These and other embodiments are described in detail below.

### BRIEF DESCRIPTION OF THE DRAWINGS

FIG. 1 shows a separated view of an embodiment of a composite material.

FIG. 2A shows a separated view of an embodiment of a toughened composite material having veils and interleaf particles.

FIG. 2B shows an embodiment of a toughened composite material having veils and interleaf particles.

FIG. 3 shows an embodiment of a method to form a toughened composite material.

### DETAILED DESCRIPTION

A toughened composite material and method of manufacturing such a composite material are disclosed. The toughened composite material can contain a synergistic combination of veils and interleaf particles in order to toughen the composite. In some embodiments, the interleaf particles and veils can be used in combination with a prepreg to form the toughened composite.

The term “prepreg” as used herein has its ordinary meaning as known to those skilled in the art and thus includes sheets or lamina of fibers that have been combined with a matrix material. The matrix material may be present in a partially cured state. Typically a prepreg is in a form that is ready for molding and curing into the final composite part and is commonly used in manufacturing load-bearing structural parts and particularly aerospace composite parts, such as wings, fuselages, bulkheads and control surfaces.

The term “fiber” as used herein has its ordinary meaning as known to those skilled in the art and may include one or more fibrous materials adapted for the reinforcement of composites. Fibers may take various forms known to those skilled in the art, including fibrous particles and flakes, whiskers, short fibers, continuous fibers, discontinuous fibers, sheets, plies, fabrics, and combinations thereof. Continuous fibers may further adopt any of unidirectional, multi-dimensional (e.g., two- or three-dimensional), non-woven, woven, knitted, stitched, wound, and braided configurations, as well as swirl mat, felt mat, and chopped mat structures. Woven fiber structures may comprise a plurality of woven tows having about 125,000 filaments or less, about 56,000 filaments or less, about 48,000 filaments or less, about 24,000 filaments or less, about 12,000 filaments or less, about 6,000 filaments or less, about 3,000 filaments or less, about 1,000 filaments or less, or about 125,000 filaments or greater. In further embodiments, the tows may be held in position by cross-tow stitches, weft-insertion knitting stitches, and/or a small amount of resin, such as a sizing.

The composition of the fibers may be varied, and is not limiting. For example, various embodiments of the fiber composition include, but are not limited to, glass, carbon, aramid, quartz, basalt, polyethylene, polyester, poly-p-phenylene-benzobisoxazole (PBO), boron, silicon carbide, polyamide, and graphite, and combinations thereof. In some embodiments, the fiber can be carbon, fiberglass, aramid or a thermoplastic material. The reinforcing fibers may be organic or inorganic. Further, the fibers can include textile architectures, including those that are either continuous or non-continuous in form.

The term “interleaf” as used herein has its ordinary meaning as known to those skilled in the art and includes a layer placed between other layers in a composite material. In one embodiment, the interleaf may be positioned near the middle of a plane of a composite. For example, the interleaf is commonly found between layers of structural fibers.

“Interlaminar” as used herein in the phrase “interlaminar toughening particles” has its ordinary meaning as known to those skilled in the art and in some embodiments includes the intended use of the particles in a layer placed between other layers, such as in an interleaf between layers of structural fibers, to impart a toughening effect on the cured composite material.

The terms “approximately,” “about,” and “substantially” as used herein represent an amount close to the stated amount that still performs the desired function or achieves the desired result. For example, the terms “approximately,” “about,” and “substantially” may refer to an amount that is within 10% or less of, within 5% or less of, within 1% or less of, within 0.1% or less of, or within 0.01% or less of the stated amount.

The term “at least a portion of” as used herein represents an amount of a whole that comprises an amount of the whole that may include the whole. For example, the term “a portion of” may refer to an amount that is 0.01% or greater, 0.1% or greater, 1% or greater, 10% or greater, 20% or greater, 30% or greater, 40% or greater, 50% or greater, 60% or greater, 70% or greater, 80% or greater, 90% or greater, 95% or greater, 99% or greater, or 100% of the whole.

The term “toughness” as used herein has its ordinary meaning as known to those skilled in the art and can be determined by various tests, specifically, compression after impact (CAI), mode 1 (double cantilever beam—G_{IC}) and/or mode 2 (end notch flex—G_{IIC}) fracture toughness. Accordingly, a material that exhibits improved toughness can be a material that achieves higher toughness results according to the above referenced tests.

The term “synergistic” as used herein has its ordinary meaning as known to those skilled in the art. Specifically, mechanical property enhancements, as determined by testing results (e.g. CAI, GIIC, GIC, and OHT), to a composite provided by at least two modifications can be considered synergistic if the mechanical testing results are improved over the values achieved with the use of either modification alone. Those skilled in the art understand that the usual expectation is that when multiple modifications (such as the addition of veils or particles) to a composite material are made, the resulting change to a particular mechanical property is likely to be an averaging of the individual modifications as reflected by mechanical testing results that are the weighted average value of the modifications, not the sum of the mechanical testing results, or the mechanical property would be the weakest of the two modifications. This is because mechanical testing results reflect the “weakest link”, typically the modification that produces the least enhancement of the mechanical property at issue. For example, as the composite is only as strong as its weakest part, cracks can and will propagate through that weak portion. Accordingly, when two types of modifications, such as embodiments of the veils and particles disclosed below, result in higher mechanical properties than either of modifications alone, or higher mechanical properties than a weighted average of the two, a person having ordinary skill in the art of composite materials would understand this to be a synergistic improvement.

FIG. 1 generally illustrates aspects of a composite material similar to those described in detail below but lacking the increased toughness. As shown in FIG. 1, the composite material 100 can be formed from one or more fibers 102 and an interlaminar polymer matrix 104. The configuration of the fibers 102 is not limited and can be formed in, for example, a fabric, a sheet, or a filament as described in detail above. The fibers 102 can be incorporated into a prepreg, and therefore can be combined with uncured polymer. The fibers 102 can then be laminated by the polymer matrix 104, thereby creating a composite material having generally alternating layers of fibers 102 and polymer matrix 104. In some embodiments, multiple layers of the composite material 100 can be formed on top of one another, thereby creating layers of composite material 100. The size and dimension of the composite material, as well as the number of composite materials used, are not limiting.

In general, composite materials such as those described with respect to FIG. 1 can be anisotropic, meaning that the strength and elastic modulus in the fiber direction can be very high, but those same properties in the other directions are lower. Further, composite materials can be formed with low or undesirable toughness, due at least in part to the requirements of having interface surfaces between layers of polymer matrix and fibers. While the fibers themselves can be strengthened, impact resistance and other properties of the composite material may not be fundamentally improved by enhancement of the strength of the reinforcing fibers since they are affected by inter-layer fracture. The inter-layer region of the composite material is that region in the vicinity of the interface between laminated layers. This region tends to have a lower content of reinforcing fibers and, since the reinforcing fibers can be differently oriented on both sides of the interface, fracture can be likely to occur in the inter-layer region. Especially in composite materials with a thermosetting resin as the polymer matrix, impact resistance can be insufficient as the polymer matrix generally can have low toughness. Furthermore, if a tensile load is applied onto a crossed laminate, inter-layer peeling often can occur at an end of the laminate.

Accordingly, disclosed herein is a method for increasing toughness of a composite material, such as impact resistance, as well as a composite material with improved toughness. For example, in some embodiments pre-impregnated composite material (“prepreg”) can comprise reinforcing fibers, an epoxy resin matrix, a veil, and one or more polymeric interleaf toughening particles. In some embodiments, the toughening particles can be insoluble in the epoxy resin matrix, or partially soluble or swellable in the resin matrix, or a combination of both. In some embodiments, the toughening particles can be inorganic or organic polymers which may be insoluble or at least partially soluble in the epoxy resin matrix. In some embodiments of the cured composite, the particles and veil remain predominantly in the interlaminar region.

The synergistic use of veils and particles can result in a composite material with improved damage tolerance, improved compression after impact (CAI), mode 1 (double cantilever beam—G_{IC}) and/or mode 2 (end notch flex—G_{IIC}) fracture toughness, as well as good balance in notched compression and notched tension properties. The combination of veils and particles can have a synergistic effect on the composite material, increasing the toughness to levels that are unexpectedly greater than would be expected based on the weighted average of their individual effects.

### Interleaf Toughening Particles

In some embodiments, one or more interleaf toughening particles can be used to increase the toughness of a composite material. These particles can be, for example, mixed into the polymer matrix used to laminate a prepreg containing fibers. In some embodiments, the interleaf particles can impart a good balance of notched tension and compression properties, as well as impart good fracture toughness.

In some embodiments, interleaf particles can comprise a polyamide (nylon) or partially aromatic nylon such as polyphthalamide (PPA). In some aspects, the particles can be cross-linked polyether sulfone (PES) based particles (e.g., PILT101 from Cytec Industries Inc., Woodland Park, N.J., USA). In some embodiments, the particles may be non-covalently cross-linked thermoplastics. In some embodiments, thermoplastic insoluble particles or organic insoluble particles can be used. In some embodiments, the interleaf particles can be polymers which can be in the form of homopolymers or copolymers (including terpolymers, block copolymers, and/or graft copolymers).

The interleaf particles can be, for example, P84 (manufactured by HP Polymer Inc. and having a polyimide polymer chemistry), xKM (manufactured by Cytec and having a polyether sulfone chemistry), or PPO (manufactured by Sabic and having a polyphenylene ether chemistry) particles. In some embodiments, ULTEM™ resin (polyether imide (PEI)) particles can be used (manufactured by Sabic). In some embodiments, PPO is non-swellable, and xKM and P84 are swellable particles. The particles in the composite can be a single type of particle (e.g., PPO) or can be a mixture of more than one particle, though the type of particle is not limiting.

In some embodiments, the interleaf particles can be thermoplastic particles, which may be thermoplastic resins having single or multiple bonds selected from carbon-carbon bonds, carbon-oxygen bonds, carbon-nitrogen bonds, silicon-oxygen bonds, and carbon-sulfur bonds. One or more repeat units may be present in the polymer that incorporate one or more of the following moieties into either the main polymer backbone or into side chains pendant to the main polymer backbone: amide moieties, imide moieties, ester moieties, ether moieties, carbonate moieties, urethane moieties, thioether moieties, sulfone moieties and carbonyl moieties. Thermoplastic particles can also have a partially cross-linked structure. The particles may be either crystalline or amorphous or partially crystalline.

In some embodiments, the interleaf particles can be at least about 5, 10, 15, 20, 25, or 30 microns in size or greater. In some embodiments, the interleaf particles can be at least about 80, 75, 70, 65, 60, 55, 50, 45, 40, 35, 30, 25 or 20 microns in size or less, although the size of the particles are not limiting. In some embodiments, when the particles are embedded in a polymer matrix, the particles can be about 5, 10, 15 or 20 wt. % of the total weight of the polymer matrix/particles, preferably about 10 wt. %. In some embodiments, 5 wt. % or more of the total weight of the polymer matrix/particles is particles. In some embodiments, about 5 wt. % to about 15 wt. % of the total weight of the polymer matrix/particle combination is particles.

In some embodiments, the particles may be substantially spherical. In some embodiments, the particles are not substantially spherical, but rather are irregularly shaped due to crushing, for example, by milling or cryo-grinding the particles. In some embodiments, the particles may be in the form of spherical particles, milled particles, flakes, whiskers, short fibers, and combinations thereof.

Examples of particles which can be used in the disclosed composite are described in U.S. Patent Publication No. 2012/0164455. Furthermore, insoluble thermoplastic particles can be used as interleaf particles as indicated by U.S. Pat. Nos. 4,957,801; 5,087,657; 5,169,710; 5,268,223; 5,242,748; 5,434,226; 5,605,745; and 6,117,551. Pre-formed rubber particles can also be used and are described in, for example, U.S. Pat. Nos. 4,783,506; 4,977,215; 4,977,218; 4,999,238; 5,089,560; and 6,013,730. Other patents, for example, U.S. Pat. Nos. 5,266,610; and 6,063,839, disclose core-shell rubber particles. Likewise, silicone based particles were also developed for toughening purposes (see, e.g., U.S. Pat. No. 5,082,891). Engineered cross-linked thermoplastic particles are described in U.S. Patent Publication Nos. 2010/0304118 and 2010/0305239. However, other types of toughening particles can be used, and the type of particle is not limiting.

### Veils

Composite materials having one or more thermoplastic veils incorporated with the polymer matrix can also improve the overall toughness of the composite. The veil can act to keep a certain quantity of resin on the surface of the prepreg, to improve the tackiness compared to ordinary prepregs, and/or to keep the temporal change of tackiness very small. The veil can include, for example, a group of fibers, such as thermoplastic resin fibers, distributed around the outside of prepreg in a composite material.

The term “veil” as used herein has its ordinary meaning as known to those skilled in the art and may include one or more strengthening or toughening materials that can at least partially cover a prepreg. In some embodiments, the veil can contain fibers formed into, for example, a mat or fabric to place at least partially around the prepreg. In some embodiments, the veil can be located in the interlaminar regions between prepreg.

In some embodiments, the veil can have an orientation different from the orientation of the fibers in a prepreg. For example, the veil can have an orientation that is orthogonal to the direction of the fibers in the prepreg. In some embodiments, the veil can have a random orientation when located around the prepreg. Specifically, the veil can be organized so that the same pattern is not repeated in constant intervals, and therefore, for example, parallel alignment of filaments and regular fabric structures can be avoided. In some embodiments, a long-fiber nonwoven fabric can have improved qualities over a woven fabric, and in addition a second set of veil structure would not have to be formed. The random orientation can be formed through numerous methods, such as a general spraying of the veil onto the prepreg, and does not require any particular methodology and/or equipment to be used.

In some embodiments, the veil fibers can be formed from a thermoplastic resin. The fibers can have a length of about 1, 2, 3, 4, 5, 6, 7, 8, 9, or 10 cm in length, or about 1 cm or greater in length. In some embodiments, the veils can be, for example, low areal weight veils having low grams per square meter (GSM). In some embodiments, the veils can have an areal weight of about 3, 4, 5, 6, 7, 8, or 9 GSM, preferably about 3 to about 9 GSM, more preferably about 4 to about 6 GSM. In some embodiments, if the GSM of the veil was below 3, the veil may not adequately hold together. Preferably, a uniform weight of the veil is used, thereby achieving more uniform physical properties.

As mentioned, the veil can be made from a thermoplastic resin. For example, polyethylenes, polypropylenes, polyphenylene oxides, polyimides, polyesters, polyether ketones, polyether imides, polyamidoimides, polyaramids, polyether ether ketones, polycarbonates, polyacetals, polyphenylene sulfides, polyarylates, polysulfones, polyether sulfones, and polybenzimidazoles can all be used as the veil. Further, combinations of materials can be used to form the veil, either as separate strands or formed into larger fibers. Therefore, these materials can have high impact toughness, and therefore can be used to increase the overall toughness of embodiments of the disclosed composite material. Further, some materials, such as polyamides, can be very high in toughness, and can have high heat resistance.

In some embodiments, the veil can be distributed around the surface of the prepreg. The veil can be distributed to have a surface thickness of about 15 to about 40 mils, preferably about 30 mils or less. In some embodiments, higher GSM veils may have thicker cross sections because the random “matt” of the veil can have many crossover points. In some embodiments, the veil can be placed directly on a prepreg thereby increasing the overall toughness of the composite material. In some embodiments, there can be space or an intervening material, such as polymer, between the veil and the prepreg. In some embodiments, the veil can be located relatively close to the prepreg, for example, within about 50, 40, 30, 20, or 10% of the thickness of the prepreg. In some embodiments, the veil can be directly in contact with the prepreg.

The veil can be located around all sides of the prepreg, though not necessarily covering the entirety of the prepreg, as mentioned above. Therefore, the prepreg can be configured to have generally similar toughness characteristics on all sides, reducing any need to determine the toughened side during lamination. However, in some embodiments, the veil is only located on one side of the prepreg. Therefore, the composite could exhibit high toughness on one side, while be generally less tough on the other side. However, two prepreg pieces could be laminated together with the veil on the outside, therefore increasing the overall toughness while minimizing the total amount of veil in the composite material.

To obtain a composite material higher in impact resistance, the elastic modulus and/or yield strength of the material of the veil can be lower than those of the polymer matrix. However, if the elastic modulus of the material of the veil is too low, the veil can be deformed during molding due to variations in conditions such as pressure, temperature and heating rate, so that the thickness of the inter-layer region of the laminate fluctuates. As a result, the composite material can have unstable physical properties. Accordingly, in some embodiments, the veil can have an elastic modulus in a range from about 10, 20, 30, 40, 50, 60, 70, 80, 90, or 100 kg/mm² to about 100, 200, 300, 400, 500, 600, 700 or 800 kg/mm². In some embodiments, the elastic modulus of the veil can be about 10, 20, 30, 40, 50, 60, 70, 80, 90, or 100 kg/mm² to about 1000, 2000, 3000, 4000, 5000, 6000, 7000, 8000, or 9000 kg/mm². In some embodiments, about 2, 3, 4, 5, 6, 7, 8, 9, or 10 wt. % to about 10, 20, 30, 40, 50, 60 or 70 wt. % of veil is used based on the total weight of the prepreg or composite material. If the amount of veil is too low, the composite material may not have sufficient toughness. If too much veil is used, the prepreg can have reduced drapability and tackiness.

### Polymer Matrix

The terms “matrix”, “resin” and “polymer matrix” as used herein have their ordinary meaning as known to those skilled in the art and thus include the polymeric material (e.g., thermosetting material) into which the reinforcing fibers of the composite are embedded. The matrix may include various components such as toughening interleaf particles. For example, in some embodiments, a matrix generally refers to a combination of the epoxy resin, the particles and the curing agent, that may also include a soluble thermoplastic toughening agent.

The term “epoxy thermosetting resin” as used herein may have its ordinary meaning as known to those skilled in the art and include epoxy resins and combinations of epoxy resins, and precursors thereof.

In some embodiments, the polymer matrix can be made from epoxides, bis-maleimides (BMI), cyanate ester, benzoxazine, polyimide, polyetherketoneketon (PEKK), polyether ether ketone (PEEK), or blends thereof. In some embodiments, epoxy resins may be used as the polymer matrix. Epoxy resins can include difunctional epoxy resins, that is, epoxy resins having two epoxy functional groups. The difunctional epoxy resin may be saturated, unsaturated, cycloaliphatic, alicyclic or heterocyclic.

Difunctional epoxy resins, by way of example, include those based on: diglycidyl ether of Bisphenol F, Bisphenol A (optionally brominated), glycidyl ethers of phenol-aldelyde adducts, glycidyl ethers of aliphatic diols, diglycidyl ether, diethylene glycol diglycidyl ether, Epikote, Epon, aromatic epoxy resins, epoxidised olefins, brominated resins, aromatic glycidyl amines, heterocyclic glycidyl imidines and amides, glycidyl ethers, fluorinated epoxy resins, or any combination thereof. A difunctional epoxy resin may be used alone or in any suitable combination with other difunctional or multifunctional epoxies.

Epoxy resins may include multifunctional epoxies, such as those having at least one meta-substituted phenyl ring in its backbone, which may be trifunctional, tetrafunctional, or a combination thereof. In some embodiments the multifunctional epoxy resins may be saturated, unsaturated, cylcoaliphatic, alicyclic or heterocyclic.

Suitable multifunctional epoxy resins, by way of example, include those based upon: phenol and cresol epoxy novolacs, glycidyl ethers of phenolaldelyde adducts; glycidyl ethers of dialiphatic diols; diglycidyl ether; diethylene glycol diglycidyl ether; aromatic epoxy resins; dialiphatic triglycidyl ethers, aliphatic polyglycidyl ethers; epoxidised olefins; brominated resins; aromatic glycidyl amines; heterocyclic glycidyl imidines and amides; glycidyl ethers; fluorinated epoxy resins or any combination thereof.

A trifunctional epoxy resin will be understood as having the three epoxy groups substituted either directly or indirectly in a para or meta orientation on the phenyl ring in the backbone of the compound. A tetrafunctional epoxy resin will be understood as having the four epoxy groups substituted either directly or indirectly in a meta or para orientation on the phenyl ring in the backbone of the compound.

It is also envisaged that the phenyl ring may additionally be substituted with other suitable non-epoxy substituent groups. Suitable substituent groups, by way of example, include hydrogen, hydroxyl, alkyl, alkenyl, alkynyl, alkoxyl, aryl, aryloxyl, aralkyloxyl, aralkyl, halo, nitro, or cyano radicals. Suitable non-epoxy substituent groups may be bonded to the phenyl ring at the para or ortho positions, or bonded at a meta position not occupied by an epoxy group. Suitable tetrafunctional epoxy resins include N,N,N′,N′-tetraglycidyl-m-xylenediamine (available commercially from Mitsubishi Gas Chemical Company (Chiyoda-Ku, Tokyo, Japan) under the name Tetrad-X), and tetradlycidyl meta-xylenediamine (available as ERISYS™ GA-240 from CVC Thermoset Specialties, Moorestown, N.J.). Suitable trifunctional epoxy resins, by way of example, include those based upon: phenol and cresol epoxy novolacs; glycidyl ethers of phenolaldelyde adducts; aromatic epoxy resins; dialiphatic triglycidyl ethers; aliphatic polyglycidyl ethers; epoxidised olefins; brominated resins, aromatic glycidyl amines and glycidyl ethers; heterocyclic glycidyl imidines and amides; glycidyl ethers; fluorinated epoxy resins or any combination thereof.

Trifunctional epoxy resins include triglycidyl meta-aminophenol. Triglycidyl meta-aminophenol is available commercially from Huntsman Advanced Materials (Monthey, Switzerland) under the trade name Araldite® MY 0600, and from Sumitomo Chemical Co. (Osaka, Japan) under the trade name ELM-120.

Additional examples of suitable multifunctional epoxy resin include, by way of example, N,N,N′,N′-tetraglycidyl-4,4′-diaminodiphenyl methane (TGDDM, available commercially as Araldite® MY 720 and MY 721 from Huntsman Advanced Materials (Monthey, Switzerland), or ELM-434 from Sumitomo Chemical Co., Ltd., Tokyo, Japan), triglycidyl ether of para aminophenol (available commercially as Araldite® MY 0500 or MY 0510 from Huntsman Advanced Materials), dicyclopentadiene based epoxy resins such as Tactix 556 (available commercially from Huntsman Advanced Materials), tris-(hydroxyl phenyl), and tris-(hydroxyl phenyl) methane-based epoxy resin such as Tactix 742 (available commercially from Huntsman Advanced Materials). Other suitable multifunctional epoxy resins include D.E.N.™ 438™ and D.E.N.™ 439™ (epoxy novolac resin reaction products of epichlorohydrin and phenol-formaldehyde novolac from Dow Chemicals, Midland, Mich., USA), and epoxy creosol novolac resins such as Araldite® ECN 1273 and Araldite® ECN 1273 (from Huntsman Advanced Materials, The Woodlands, Tex., USA).

The epoxy resin can be present in a range of about 1 wt. % to about 99 wt. % of the polymer matrix/veil/particle composition. Preferably, the epoxy resin can be present in a range of about 10 wt. % to about 70 wt. %. More preferably, the epoxy resin can be present in a range of about 25 wt. % to about 60 wt. %.

In some embodiments, the epoxy thermosetting resin can be capable of causing the interleaf particles to swell. In some embodiments, the epoxy thermosetting resin can be incapable of substantially dissolving the interleaf particles. “Substantially dissolving” or “substantially soluble” includes forming a substantially homogeneous combination.

The terms “cure” and “curing” as used herein have their ordinary meaning as known to those skilled in the art and may include polymerizing and/or cross-linking processes that result in hardening of the uncured matrix. Curing may be performed by processes that include, but are not limited to, heating, exposure to ultraviolet light, electron beam, and/or exposure to radiation. Prior to curing, the matrix may further comprise one or more compounds that are at about room temperature, liquid, semi-solid, crystalline solids, and combinations thereof. In further embodiments, the matrix within the prepreg may be partially cured in order to exhibit a selected stickiness or tack and/or flow properties.

### Synergistic Toughened Composite Material

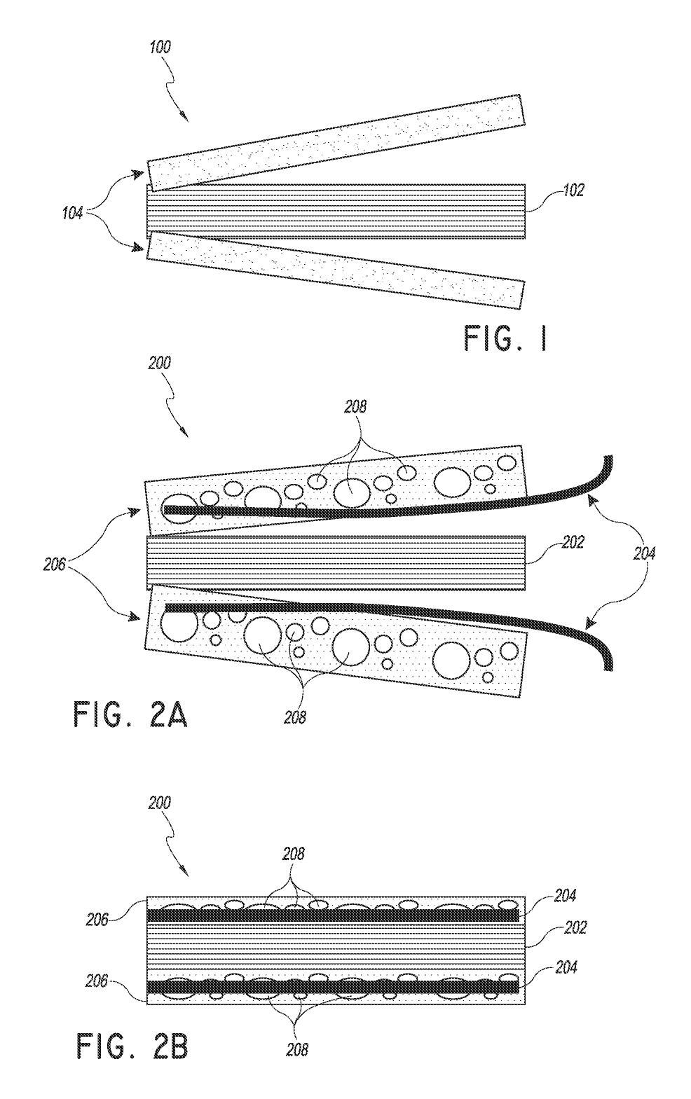

FIGS. 2A-B illustrate an embodiment of a toughened composite material 200 which can include at least one veil 204 and at least one interleaf particle 208. FIG. 2A shows the composite material split into pieces, and FIG. 2B shows an embodiment of a final composite material product. As shown, the composite material 200 can comprise a first layer having a plurality of fibers 202, such as reinforcing fibers. These fibers 202 can be untreated fibers, or can be arranged and embedded in a polymer matrix, in which case the fibers 202 form a prepreg. The fibers 202 can be carbon fibers, glass fibers, ceramic fibers, or combinations thereof, and the type of fiber is not limiting.

Veils 204 or another interlaminar layer can be placed around the fibers 202. In some embodiments, the veils 204 can completely surround the fibers 202 whereas in other embodiments the veils 204 only partially surround the fibers 202. In some embodiments, the veils 204 can overlap one another whereas in other embodiments there may not be overlap of the veils 204. In some embodiments, the veils 204 can be located directly on the fibers 202.

The fiber/veil composition can be laminated with a laminating matrix, such as a polymer 206. The polymer 206 can contain toughening particles 208 throughout. The toughening particles 208 can be located randomly throughout the polymer 206 or can be arranged in a specific pattern. The entire uncured composite 200 can then be cured into a final product as illustrated in FIG. 2B. The combination of veil 204 and toughening particles 208 synergistically provide the composite material 200 with improved toughness.

In some embodiments, the toughening particles 208 and veil 204 can be located within the interlaminar polymer layers 206. As discussed above, the composite material 200 can have multiple layers therein. After the final composite 200 is formed, there can be generally two layers. The first layer can include the plurality of fibers 202 and a polymer matrix. The second layer can include the combination of polymer 206, veils 204, and toughening particles 208. The second layer 206/204/208 can contact and at least partially cover the first layer of fibers 202. The particles 208 and veil 204 can be dispersed through the polymer 206. Further, the particles 208 can generally move within the polymer 206 to a location near the veil 204 which can be located on the outer edge of the second layer.

The above described layers may not necessarily be as distinct, and the layers may comingle to some extent with each other. For example, there may not be sharp lines between the layers, and veil 204 can enter into polymer 206 or into fibers 202.

### Methods of Forming Toughened Composite

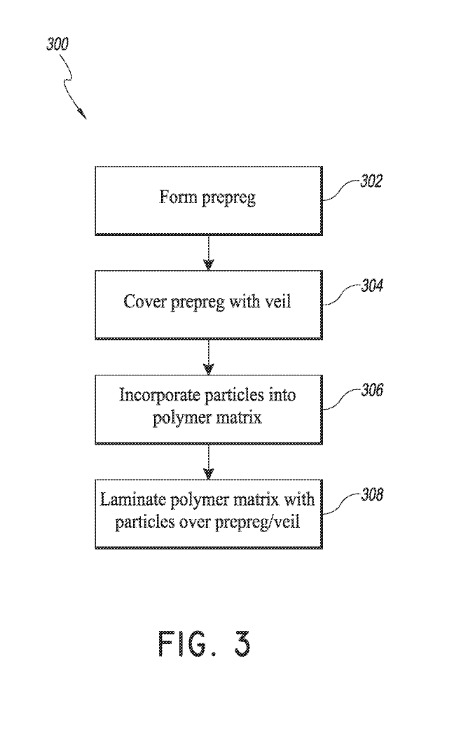

FIG. 3 shows an embodiment of a method 300 for forming a toughened composite material as disclosed above.

First, a first layer of prepreg is formed 302. The prepreg can be formed by conventional methods known to those having skill in the art, and the formation of the prepreg is not limiting. The prepreg can be purchased from an outside manufacturer. After the prepreg is obtained, the prepreg can be at least partially covered with a second interlaminar layer, such as a veil 304. In some embodiments, the veil can be in contact with the prepreg. The veil can become part of the prepreg as it can be embedded into the prepreg resin matrix. The veil can be oriented in the direction of the prepreg, or it can be oriented in the direction opposite that of the prepreg. In some embodiments, the veil can be arranged at random on the surface of the prepreg. The prepreg/veil can be heated, and the surface can be pressed so that the veil is at least partially impregnated into the prepreg. However, this heating/pressing step is not required. In another method, the veil can be placed onto a tacky resin prepreg surface and later, such as during the cure, the veil can become embedded in the prepreg.

Further, the first and second layers can be laminated with a third layer, such as a polymer matrix to form a laminated prepreg 308. Before lamination, toughening particles can be incorporated into a polymer matrix 306. Once the particles are incorporated, the prepreg at least partially covered by the veil can be laminated by the polymer matrix having the toughened particles. In some embodiments, the particles can migrate from their location in the polymer matrix so that they are next to the veil. Once the prepreg has been laminated 308, the laminated prepreg can be cured to form a composite product.

### Examples

The following examples are provided to assist one skilled in the art to further understand certain embodiments of the present disclosure. These examples are intended for illustration purposes only and are not to be construed as limiting the scope of the claims of the present disclosure. Methods of making various embodiments of the composite materials according to the disclosure are exemplified below.

Tables I-III illustrate the results of testing performed on composites made using non-woven carbon, glass, and thermoplastic veils. In the testing, when a veil is added, it is added to the same percentage of particles as were tested without the veil.

TABLE I
Veil and Particle Testing Results in Epoxy 5311B *-G30-700+ **

| | GIC (in- | G_{IIC} (in- | CAI @ 270 |
|---|---|---|---|
| Veil Each Layer | lbf/in²) | lbf/in²) | in-lbs (ksi) |
| 5311B-PPO, G30-700 + | 2.4 | 12 | 50 |
| no Veil | | | |
| Spunfab Nylon | 1.3 | 12 | 41 |
| Copolyamide PA1453 | | | |
| Veil no PPO | | | |
| Kevlar ® aramid Veil *** | 2 | 15 | N/A |
| PPO + PA1453 Veil | 1.6 | 20 | 56 |
| PPO + Kevlar ® Veil | 2.5 | 16 | N/A |

* Epoxy 5311B is an epoxy resin available from Cytec Industries Inc., Woodland Park, New Jersey, USA
** G30-700+ is carbon fiber available from Toho Tenax American, Inc., Rockwood, Tennessee, USA
*** Kevlar ® aramid is a para-aramid available from Dupont USA, Wilmington, Delaware, USA

TABLE II
Veil and Particle Testing Results in Epoxy 5311C ^{#}-TRZ50 Carbon Fiber ^{##}*

| Veil Each Layer | G_{IC} (in-lbf/in²) | G_{IIC} (in-lbf/in²) | CAI (ksi) |
|---|---|---|---|
| xKM Particle | 2.5 | 4.4(3.5) | 46 |
| PA1453-Nylon Veil | N/A | N/A | N/A |
| Kevlar | N/A | N/A | N/A |
| xKM + PA1453 Veil | 3.8 | 6.8 | 54 |
| xKM + Kevlar Veil | 4.5 | 13.9 | 47 |

^{#} Epoxy 5311C is an epoxy resin available from Cytec Industries Inc., Woodland Park, New Jersey, USA
^{##} available from Mitsubishi Rayon Co. Ltd., Tokyo, Japan

TABLE III
Veil and Particle Testing Results in IM8GP 12k carbon fiber ^{&}
with 5261 BMI resin ^{&&} formula
BMI 5261 + P84 Particle

| Veil Each Layer | G_{IC} (in-lbf/in²) | G_{IIC} (in-lbf/in²) | CAI (ksi) |
|---|---|---|---|
| P84 Only | 1.8 | 9.9 | 38.4 |
| Kevlar Veil | N/A | N/A | N/A |
| P84 + Kevlar Veil | 3.3 | 17.1 | 40 |

^{&} Available from Hexcel Corporation, Stamford, Connecticut, USA
^{&&} Bismaleimide resin available from Cytec Industries Inc., Woodland Park, New Jersey, USA

As shown in the tables herein, use of embodiments of a thermoplastic veil with embodiments of a thermoplastic interleaf particle in a composite material can achieve unexpected synergistic results.

As shown above, the combination of particles and veils can have a substantial effect on the composite material. For example, in Table I, both combinations of PPO particles and veil (PA1453, manufactured by Spunfab and having a nylon-6 type polymeric chemistry or Kevlar®, manufactured by Dupont, having an aromatic polyamide chemistry) show overall improvements in the G_{IIC} test. Further, the combination of PPO with the PA1453 veil shows an improvement in the CAI test.

Table II also shows the synergistic effect of the combination of particles and veils. Similar to Table I, the combination of particles and veils is superior to either one of the elements alone. In fact, the use of xKM particles and the Kevlar veil is over triple the G_{IIC} value as that of the xKM particles alone.

Table III also shows improvements that can be made through the synergistic use of particles and veils. Use of P84 particles with a Kevlar® veil leads to an increase in all tests.

As shown above, composites containing polyamide type veils (e.g., Kevlar® and Nylon based veils) showed toughness improvements as measured by CAI and G1/G_{IIC}. Veil chemistry can be selected to combine best with the polymer composition. For example, as shown above, the Kevlar® veil performed better with BMI chemistry, and the Nylon type polyamide veil performed better with epoxy formulations.

Table IV shows the results of further testing that was done with xKM and PPO particles alone and in combination with a polyamide veil.

TABLE IV
Veil and Particle Testing Results in Epoxy 5311C and
MRZ60 Carbon Fiber with PA1453 Veil

| | | xKM | | PPO |
|---|---|---|---|---|
| | xKM | Particle + | PPO | Particle + |
| | Particle | Veil | Particle | Veil |
| CAI 270 (in-lbs) | 46.2 | 55.3 | 50.3 | 56 |
| DCB G_{IC} (in-lbf/in²) | 1.874 | 2.247 | 2.385 | 3.202 |
| ENF G_{IIC} 1^{st} (ave) | 5.2 | 8.1 | 12 | 16.9 |
| (in-lbf/in²) | | | | |
| OHC RT (ksi) | 42.4 | 41.8 | 42.2 | 43.5 |
| OHC hot wet; 2 wk | 32.4 | 28 | 31.8 | 26.8 |
| soak at 160° F. then | | | | |
| test at 180° F. (ksi) | | | | |

As shown again in Table IV, the use of the synergistic combination of particles and veils can improve the toughness results under CAI, G_{1C}, and G_{IIC}. Further, the drop-offs under the open hole compression (OHC) test were minimal, only around 14-16%. In addition, toughness actually increased in the standard OHC test with combination of PPO particles and veil.

Next, Table V illustrates a composition for an embodiment of the disclosed toughened composite material. Table VI illustrates the results of such a composition.

TABLE V
Composite Formulation for Results in TABLE VI

| Ingredient | Wt. % |
|---|---|
| Diglycidyl ether of Bisphenol F (PY 306 manufactured by Huntsman) | 24 |
| Trifunctional para-glycidyl amine (MY 0510 manufactured by Huntsman) | 24.1 |
| 4,4′ Diaminodiphenylsulfone (manufactured by Huntsman) | 24.4 |
| Polyethersulphone (5003P Thermoplastic manufactured by Sumimoto) | 17.5 |
| xKM or P84 Particles | 10 |
| PA-11 Polyamide 11 Polymeric Veil (for some tests) (manufactured by Spunfab) | 5 GSM |
| Carbon Fiber | 190 gsm |

TABLE VI
Testing Results of the Formulation of
Table V with Epoxy 5311A and IM8GP Carbon Fiber

| Carbon | | | | | | |
|---|---|---|---|---|---|---|
| Fiber | FAW = 190 | xKM | xKM + | P84 | P84 + | Veil |
| IM8-GP | RC = 33% | only | Veil | Only | Veil | Only |
| CAI (ksi) | Impact 230 in- | 52.64 | 55.4 | 47.2 | 52.4 | 46.8 |
| | lbs | | | | | |
| | Impact 270 in- | 49.3 | 52 | 43 | 51.8 | 41.8 |
| | lbs | | | | | |
| DCB/ENF | DCB G_{IC} | 1.83 | 2.26 | 1.38 | 2.47 | 1.21 |
| (in-lbf/in²) | ENF G_{IIC} | 5.9 | 17.5 | 11 | 17.2 | 3.4 |
| OHT (ksi) | RT | 88.6 | 90 | 86 | 90.2 | 81.9 |
| Hot-Wet | RT | 49.7 | 50.4 | 49 | 48.3 | 51 |
| OHC (ksi) | 2 week soak at | 43.3 | 38.6 | 41.6 | 38 | 39.7 |
| | 160° C. then test | | | | | |
| | at 180° C. | | | | | |

As shown above, when the interleaf particles xKM or P84 and a polyamide veil are used together, a synergistic improvement is shown in CAI, G_{IC}, and G_{IIC} values with no reduction and, in fact, an increase in OHT values. Although a <10% drop can be observed in the hot wet OHC values in Table VI, this reduction is minimal and indicates that other configurations can have better properties. Accordingly, a judicious choice of veil chemistry and/or backbone structure can be employed to reduce or eliminate the decrease in hot wet OHC values. Further, modification of the polymer matrix can also be used to mitigate the hot wet reduction in OHC properties.

### APPLICATIONS

Embodiments of the methods disclosed herein can be used to make a composite material having high toughness. Embodiments of the composite can then be used for a variety of purposes, all of which are non-limiting. For example, composites manufactured by the above disclosed process can be used in baseball bats, electronic cases, and golf clubs. Further, fibers can be particularly advantageous in the aerospace and automotive fields due to the high strength-to-weight ratio and good rigidity.

Although the foregoing description has shown, described, and pointed out fundamental novel features of the present teachings, it will be understood that various omissions, substitutions, and changes in the form of the detail of the apparatus as illustrated, as well as the uses thereof, may be made by those skilled in the art without departing from the scope of the present teachings. Consequently, the scope of the present teachings should not be limited to the foregoing discussion, but should be defined by the appended claims.

What is claimed is:

1. A toughened composite material comprising:
a first layer comprising a plurality of reinforcing fibers arranged in a fiber configuration and embedded in a polymer matrix; and
a second layer contacting and at least partially covering the first layer, the second layer comprising a laminating matrix, wherein the laminating matrix comprises an interlaminar layer and at least one toughening particle embedded in the laminating matrix;
wherein the interlaminar layer and the at least one toughening particle are selected in combination to synergistically provide the composite material with improved toughness.

2. The toughened composite material of claim 1, wherein the plurality of reinforcing fibers are selected from carbon fibers, glass fibers, ceramic fibers, and combinations thereof.

3. The toughened composite material of claim 1, wherein the at least one interlaminar layer comprises a veil.

4. The toughened composite material of claim 1, wherein the at least one interlaminar layer comprises a plurality of polymer fibers oriented in a different direction than a direction of the reinforcing fibers.

5. The toughened composite material of claim 1, wherein the at least one interlaminar layer comprises a plurality of polymer fibers oriented in a generally random direction.

6. The toughened composite material of claim 1, wherein the at least one interlaminar layer comprises a plurality of polymer fibers oriented in a same direction as a direction of the reinforcing fibers.

7. The toughened composite material of claim 1, wherein the at least one interlaminar layer comprises a polyamide veil.

8. The toughened composite material of claim 6, wherein the polyamide is PA1453, a polyaramid, or PA-11.

9. The toughened composite material of claim 1, wherein the at least one interlaminar layer has an areal weight in the range of about 3 GSM to about 9 GSM.

10. The toughened composite material of claim 8, wherein the at least one interlaminar layer has an areal weight of about 6 GSM.

11. The toughened composite material of claim 1, wherein the at least one toughening particle is insoluble in the laminating matrix.

12. The toughened composite material of claim 1, wherein the at least one toughening particle is at least partially soluble in the laminating matrix.

13. The toughened composite material of claim 1, wherein a material of the at least one toughening particle is chosen from polyphenylene ether resin, polyether sulfone, polyimide, and combinations thereof.

14. The toughened composite material of claim 1, wherein the laminating matrix comprises an amount of the at least one toughening particle in the range of about 5 wt. % to about 15 wt. %, based on the total weight of the laminating matrix and the toughening particles.

15. A method of forming a composite material comprising:
providing a first layer comprising a prepreg;
at least partially contacting and covering the first layer with a second layer comprising an interlaminar layer;
laminating the first and second layer with a third layer to form a laminated prepreg, the third layer comprising at least one toughening particle embedded into a laminating matrix; and
curing the laminated prepreg to form a composite material;
wherein the interlaminar layer and the at least one toughening particle are selected in combination to synergistically provide the composite material with improved toughness.
